(19) United States
(12) Patent Application Publication
(10) Pub. No.: US 2008/0190534 A1
(43) Pub. Date: Aug. 14, 2008

(54) Vehicle Wheel with Seats of Unequal Diameters and Assembly Comprising a Wheel and a Support Element

(75) Inventor: Michel Malevergne, Cebazat (FR)

Correspondence Address: FITZPATRICK CELLA HARPER & SCINTO, 30 ROCKEFELLER PLAZA, NEW YORK, NY, 10112, US

(73) Assignee: Michelin Recherche Et Technique S.A., Granges-Paccot (CH)

(21) Appl. No.: 11/996,259

(22) PCT Filed: Jul. 19, 2006
(86) PCT No.: PCT/EP2006/064403

§ 371 Date: Jan. 18, 2008

(30) Foreign Application Priority Data
Jul. 19, 2005 (FR) 0507790

(51) Int. Cl. B60B 21/02; B60B 21/04; B60B 21/10

(52) U.S. Cl. 152/379.3

(57) ABSTRACT

Vehicle wheel, with symmetry of revolution, including a disc and a rim, the rim including a first and a second seat which seats are designed to receive and to hold a first and a second bead of the tire, each seat having a substantially frustoconical bottom locally coinciding with a cone of revolution coaxial with the rim and open towards the other seat, a safety hump extending the bottom of the seat towards the other seat, and an external lip extending the bottom of the seat in the direction away from the other seat, the maximum diameter of the first seat being less than the maximum diameter of the second seat, characterized in that each seat includes, on the side facing the other seat, an adjacent circumferential groove and in that the connecting region where the disc and the rim meet is connected to the said rim on the second seat side.

### BACKGROUND OF THE INVENTION

1. Field of the Invention

The invention relates to a vehicle wheel with seats of unequal diameters and to an assembly comprising a wheel such as this and a support insert.

2. Prior Art

Application WO 01/08905 describes a vehicle wheel with seats of unequal diameters and an assembly comprising such a wheel and a support insert. The vehicle wheel set out in WO 01/08905, which has symmetry of revolution, is intended for mounting a tire and a tread support insert and comprises a disc and a rim. The rim is such that it comprises:

a first and a second seat which seats are intended to receive and to hold a first and a second bead of the tire, each seat having a substantially frustoconical bottom locally coinciding with a cone of revolution coaxial with the rim and open towards the other seat, a safety hump extending the bottom of the seat towards the other seat, and an external lip extending the bottom of the seat in the direction away from the other seat, and the maximum diameter of the first seat being shorter than the maximum diameter of the second seat; and

for the first seat towards the second seat, a first circumferential groove, a bearing surface of a diameter more or less equal to the maximum diameter of the first seat and a second circumferential groove.

This wheel is such that the disc is connected to the rim on the first seat side.

The wheel and the wheel/insert assembly set out in that document are able to run flat under excellent conditions, particularly with very low risk of the tire beads becoming unseated. However, they may exhibit excessive sensitivity to knocks, particularly on the larger-diameter seat of the wheel situated on the inboard side of the wheel.

### SUMMARY OF THE INVENTION

The subject of the invention is a similar wheel in which each seat comprises, on the side facing the other seat, an adjacent circumferential groove and in which the connecting region where the disc and the rim meet is connected to the rim on the second seat side.

This reversal of the position of the two rim seats by positioning the larger-diameter seat, or second seat, on the outboard side of the wheel, that is to say on the side connected to the disc, allows the larger-diameter region of the rim to be positioned in a very rigid region that is therefore far less sensitive to knocks than the seat on the inboard side. This also has the advantage of making it possible to reduce the weight of the wheel because of the lower mechanical fatigue stresses applied to the inboard seat or first seat.

The circumferential grooves adjacent to the seats act as mounting grooves. These grooves are designed to allow the corresponding bead of the tire to negotiate the seat when the tire is being mounted on and/or removed from the rim. It should be noted that the groove adjacent to the larger-diameter second seat has a depth (Hₘₐₓ) designed to allow only the second bead of the tire to negotiate the second seat, i.e. the first bead of the tire is unable to negotiate the second seat of the rim.

When the safety hump of the second seat comprises a region that is cylindrical of revolution, or “ledge”, of axial width L, the depth (Hₘₐₓ) of the groove adjacent to the second seat is dependent on the maximum diameter (Φ_{S2max}) of the second seat and on the axial width L of the ledge.

As a result, depending on the geometry and diameter of the second seat, the depth of the second circumferential groove may be equal to, smaller than or greater than that of the first circumferential groove.

Advantageously, the rim may, between the two grooves, have a bearing surface intended to accept a support insert.

If the same aspect, that is to say the same outside seat diameter visible when the assembly is mounted on a vehicle is maintained for the wheel/insert and tire assembly, then the wheel according to the invention has the advantage of having a bearing surface the diameter of which can be reduced appreciably, by the order of 20 mm with respect to the assemblies currently defined by the ETRTO (Standards Manual 2004, Rims, R. 14). That increases the clearance between the insert and the tread and thus reduces the magnitude of any loading liable to be transmitted to the vehicle in the event of a violent knock.

Advantageously, when the radially internal profile of the rim has, progressing from the second seat towards the region of connection with the disc, a diameter that passes through a minimum (Φ_{JImin}) then through a maximum diameter (Φ_{JImax}) positioned axially between the first and second seats, the wheel according to the invention comprises at least one passageway opening, on the one hand, into the region of the radially internal profile of the rim of a diameter somewhere between the maximum (Φ_{JImax}) and minimum (Φ_{JImin}) diameters and, on the other hand, to the outside of the wheel on the second seat side.

The presence of this passageway allows substances (water, ice, mud, various products) to be removed to the outside of the wheel and prevents them from accumulating in this interior region of the wheel.

As a preference, the passageway opens into the radially internal region of the rim with a diameter (Φ_{CI}) equal to the maximum diameter of the internal profile of the rim (Φ_{JImax}) reduced by 3 mm at most.

The region in which various substances are retained is thus small enough for the consequences of this retention to be negligible.

As a preference, the passageway coincides locally with a sector of a cone of revolution open towards the second seat.

As used herein, a cone of revolution refers to the standard definition, namely that of a solid of revolution on a circular base ending in a point.

This angling of the passageway guarantees that any substances entering the passageway will be probably expelled easily under gravity and when the wheel is rolling along, under centrifugal effects.

According to one particular embodiment, with the disc having a number of ventilation openings, the passageway is a slot formed in the radially external wall of at least one of the said openings. This slot advantageously has a cross section with a high radius of curvature.

According to another embodiment which may be coupled with the previous one, with the disc having a number of ventilation openings each positioned between two spokes, the passageway is formed in at least one of the spokes.

Advantageously, the bearing surface of the rim has a circumferential rib intended to lock the support insert in position, particularly when the axial dimension of this support insert occupies only an axial section of the area of rim between the two seats.

Another embodiment of the invention is an assembly comprising of a wheel and of a tread support insert, in which the support insert is positioned around the bearing surface and runs axially as far as the second seat.

Advantageously, the insert comprises a support part positioned around the bearing surface of the rim and a locking part positioned radially externally relative to the second circumferential groove.

As a preference, with the second seat extended towards the first seat by a sidewall of the second circumferential groove, the insert is designed to bear against the sidewall of the second circumferential groove.

That allows the locking part of the insert to collaborate with the safety hump of the second seat of the rim to guarantee excellent unseating-prevention performance of the bead of the tire without adversely affecting the ability to mount and remove the tire.

As a preference, the assembly according to the invention is such that the bearing surface of the rim comprises a circumferential slot which collaborates with a plurality of wedges positioned circumferentially on the radially internal wall of the support insert in order to lock the insert in position on the bearing surface.

The mounting of a tire on a wheel according to the invention is performed with the following method:

the second bead of the tire is placed on the wheel rim, on the side of the first seat, until its introduction in the mounting groove adjacent to the second rim seat;

the mounting of the first bead on the first seat is performed by pushing axially the bead from the outside towards the inside with a mounting roller;

the safety hump of the second seat, the second seat and the ledge of the second seat are negotiated by the second bead; and

the second bead is mounted on the second seat by pushing axially the second bead from the outside towards the inside with a mounting roller.

The mounting of a tire and support assembly on a wheel according to the invention can be performed by using the method disclosed for instance in patent EP 1 351 832 B1.

### BRIEF DESCRIPTION OF THE FIGURES

Other features and advantages of the invention will emerge from the description given hereinafter with reference to the attached drawings which, by way of non limiting examples, show some embodiments of the subject matter of the invention:

FIG. 1 shows a view in partial meridian section of, an insert, rim and tire assembly according to the invention;

FIG. 2 shows a view in partial meridian section of a wheel according to the invention;

FIG. 3 shows an external partial perspective view of a wheel according to the invention;

FIG. 4 shows an internal partial perspective view of a wheel according to the invention;

FIG. 5 shows a view similar to FIG. 2 but passing through a spoke of the disc; and

FIG. 6 shows a view in partial meridian section of an alternative form of wheel according to the invention not intended to have an insert; and

FIG. 7 shows a view in partial meridian section of another alternative form of wheel according to the invention not intended to have an insert.

### DETAILED DESCRIPTION OF THE INVENTION

As used herein, a meridian or axial plane is to be understood to mean any plane passing through the axis A of the wheel and of the rim.

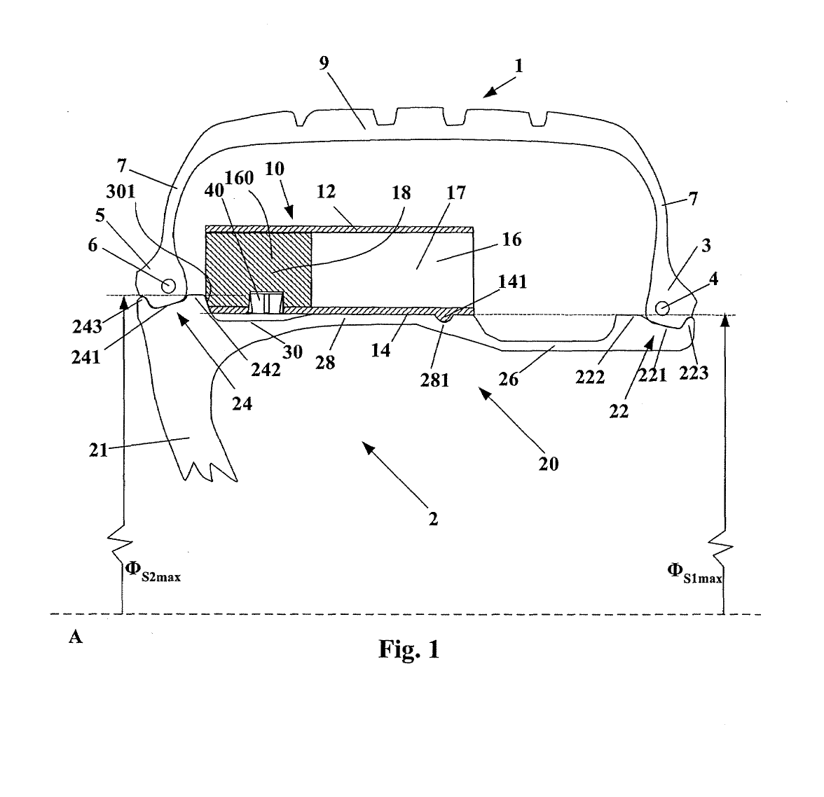

FIG. 1 shows, viewed in partial meridian or axial section, an insert 10, rim 20 and tire 1 assembly according to the invention. The rim 20 forms, with a disc 21, a one-piece wheel 2. The disc may equally be manufactured independently of the rim and joined thereto thereafter. The rim 20 comprises a first seat 22 and a second seat 24 which seats are intended to act as bearing surfaces for the first 3 and second 5 beads of the tire 1.

The first seat 22 has a frustoconical bottom 221 locally coinciding with a cone of revolution coaxial with the rim and open towards the second seat 24, a safety hump 222 extending the bottom 221 of the first seat 22 towards the second seat 24, and an external lip 223 extending the bottom 221 of the first seat on the opposite side to the second seat 24. The maximum diameter of the first seat 22 is Φ_{S1max}. This diameter corresponds to the maximum diameter of the safety hump 222.

The second seat 24 comprises a frustoconical bottom 241 that locally coincides with a cone of revolution coaxial with the rim and open towards the first seat 22, a safety hump 242 extending the bottom 241 of the second seat 24 towards the first seat 22 and an outer lip 243 extending the bottom 241 of the second seat on the opposite side to the first seat 22. The maximum diameter of the second seat 24 is Φ_{S2max}. This diameter corresponds to the maximum diameter of the safety hump 242.

The maximum diameter of the second seat is greater than that of the first seat. In the example depicted, the order of magnitude of the difference between the maximum diameters Φ_{S2max}-Φ_{S1max} is preferably of the order of 20 mm. The difference between the minimum radii of the two seats is therefore preferably of the order of 10 mm.

From the first seat 22 towards the second seat 24 there are, in succession, a circumferential groove 26, a bearing surface 28 and a second circumferential groove 30. The second circumferential groove 30 acts as a mounting groove for the second seat 24. The groove 30 has a sidewall 301 adjacent to the safety hump 242. On the bearing surface 28 there is a circumferential slot 281. The outside diameter of the bearing surface 28 corresponds more or less to the maximum diameter of the first seat 22 so as to allow the insert 10 to be slipped onto this bearing surface 28 having negotiated the first seat 22.

The tire 1 comprises two beads 3 and 5 intended to bear against the seats 22 and 24 of the rim 20, two sidewalls 7 and a tread 9. Each bead has annular reinforcements directed more or less circumferentially and which are practically inextensible. These reinforcements, such as bead wires 4 and 6, are intended, in service, to hold the beads on the rim seats.

The insert 10 essentially comprises;

a more or less cylindrical crown region 12 intended to come into contact with the tread 9 of the tire 1 in the event of a loss of pressure, but leaving clearance with respect to this tread at nominal pressure,

a more or less cylindrical sole 14 intended to fit around the rim 20, this sole comprising a plurality of wedges 141 positioned circumferentially, of more or less semi-cylindrical cross section intended to collaborate with the slot 281 to lock the insert 10 in position on the bearing surface 28 of the rim 20, and

an annular body 16 connecting the sole 14 and the crown region 12, this body comprising a collection of Y-shaped partitions 160 more or less radially connecting the sole and the crown region and directed more or less axially from one side of the insert to the other.

This insert may comprise a housing 40 which opens radially internally relative to the insert and which is intended to house an electronic module. An electronic module such as this forms part of a tire pressure monitoring system like the one disclosed in document WO 94/20317. The electronic module periodically measures the pressure and temperature of the air in the cavity comprising of the tire and the rim and also periodically sends the values of these measurements to a central processing unit where these values are analyzed and processed.

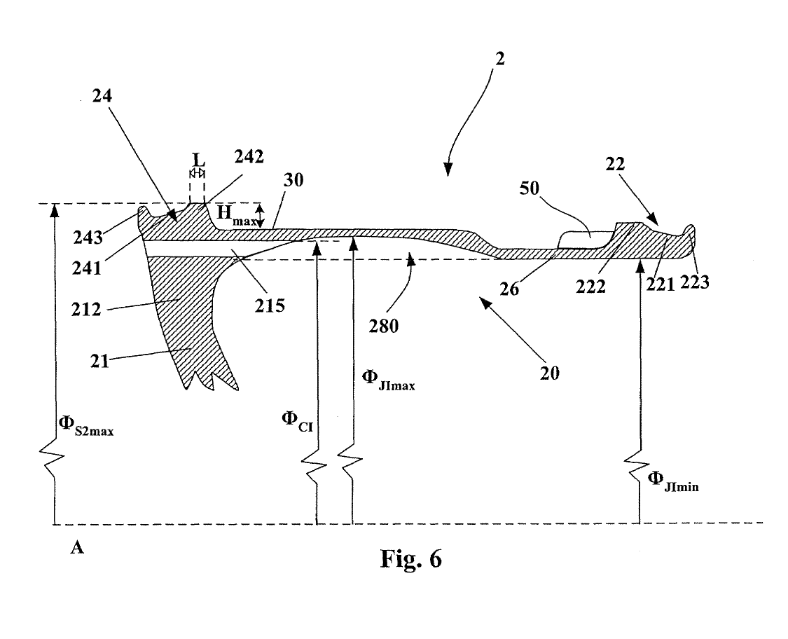

An electronic module such as this may also be fixed to the wheel valve which opens into the second circumferential groove 30; it may also be fixed to the radially external wall of the first circumferential groove 26 (see FIG. 6). This fixing may be achieved by various known means such as bonding, welding, riveting etc.

The sole 14 comprises circumferentially directed reinforcements such as steel threads or high-modulus textile reinforcements such as aramid. Their function is to oppose the centrifugal forces experienced by the insert during high-speed running to allow the insert to remain bearing against the bearing surface without shifting circumferentially. These reinforcements, which have not been depicted in the figure, are positioned axially on each side of the housing 40.

FIG. 1 shows the mounted tire 1, insert 10 and rim 20 assembly. It can be seen that the insert is positioned around the bearing surface 28 of the rim 20 and extends axially radially externally relative to the groove 30 until it comes to bear against the sidewall 301 of this groove 30. The part of the insert positioned around the bearing surface 28 is the so called “support” part; it is this support part 17 which mainly bears the load under runflat conditions with contact between the tread of the tire and the crown region of the insert. The part of the insert positioned around the groove 30 is termed the “locking” part. The function of this locking part 18 is to shelter the housing 40 and lock the second bead 5 of the tire 1 in position on its seat 24. This anti unseating function of the locking part 18 of the insert supplements the similar action of the safety hump 242 of the second seat 24.

In FIG. 1 it can be seen that the disc 21 is connected to the rim 20 on the second rim seat 24 side, that is to say on the larger diameter seat side. The safety hump 242 of the seat 24 is the larger diameter part of the rim. It is therefore this region which is the most highly mechanically stressed on curbing or when running over potholes. This region thus lies adjacent to the connection between the disc 21 and the rim 20 and therefore has good rigidity that encourages excellent mechanical resistance to knocks. The first rim seat is also less heavily mechanically loaded in comparison to wheels of the prior art and that allows the thickness of the rim to be reduced in this region and thus the overall mass of the wheel to be reduced. By comparison with a wheel with the same outboard seat or second seat diameter, a mass saving of as much as 20% can be achieved.

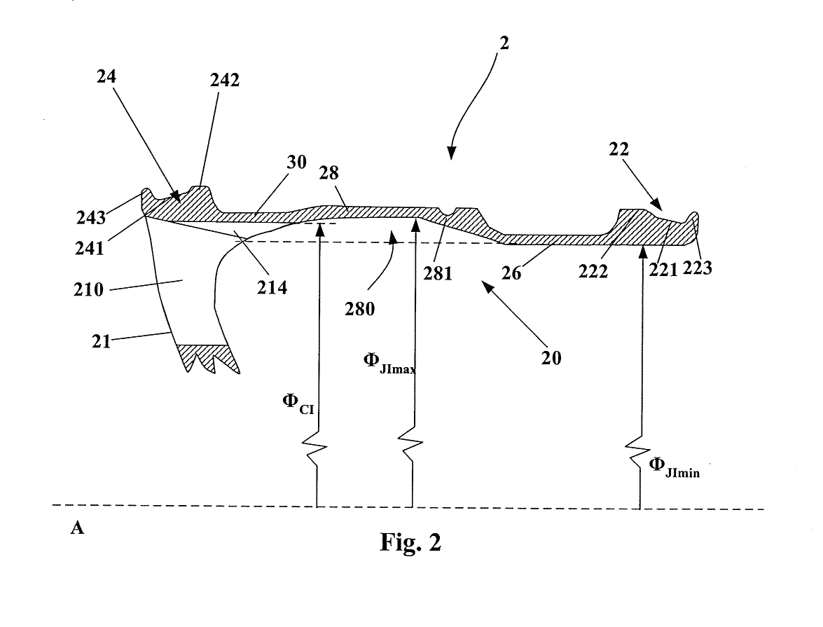

FIG. 2 shows a partial meridian section of the wheel 2 according to the invention by itself. The radially internal wall of the rim 20 has a minimum diameter Φ_{JImin} at the first seat 22 or inboard seat. Then, at the bearing surface 28, the diameter increases to a maximum value Φ_{JImax}. It can be seen that the appreciable difference between these two diameters creates a cavity 280 in which various substances such as water, ice, mud or various debris can accumulate. This accumulated material may disrupt the static and dynamic balances of the wheel, thereby creating imbalance.

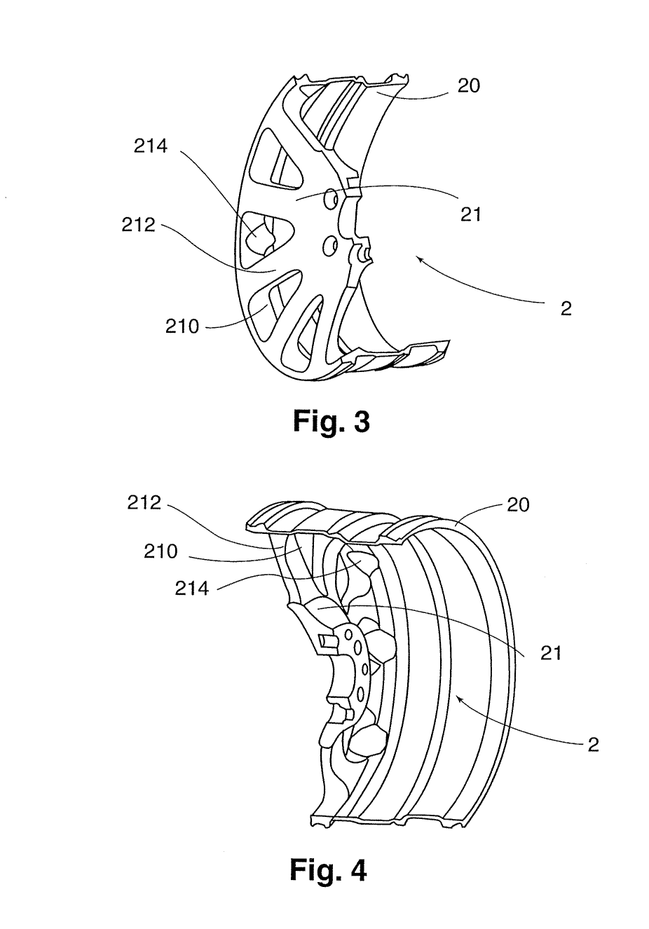

To solve this problem, the wheel according to the invention comprises a passageway, in this instance a slot 214 formed, as shown by FIGS. 2, 3 and 4, on a radially external wall of a ventilation opening 210 of the disc 21. This passageway or slot 214 has a cross section with a high radius of curvature and opens on the inboard side of the disc 21 into the cavity 280 at an axial distance Φ_{CI}/2 of less than 3 mm from the maximum diameter region Φ_{JImax} of the internal face of the rim. A small residual thickness such as this allows the issues of retention of various substances in the cavity 280 to be rendered practically negligible. The slot 214 opens onto the other side of the disc at an axial distance very slightly greater than the distance Φ_{JImax}, so that the slot is angled slightly to encourage removal.

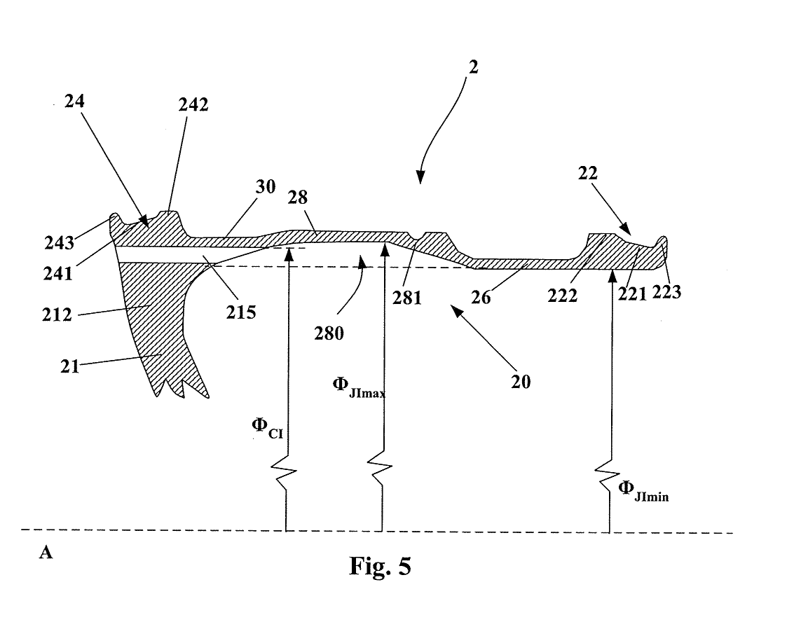

The removal passageways may also be produced in a spoke 212. FIG. 5 shows a cross section similar to that of FIG. 2 but passing through the spoke 212. The important thing is for the volume of the cavity 280 to be limited similarly. In this figure, the passageway 215 can be seen to open, at one end, into the cavity 280 and, at the other end, onto the outside of the disc 21.

The fact of having a support insert that comes to bear against the sidewall 301 of the groove 30 adjacent to the safety hump 242 makes it possible to substantially reduce the width of the hump 242 relative to the frustoconical bottom 241 of the seat 24. This then makes it possible to reduce the depth of the circumferential groove 30 accordingly without adversely affecting the ability to mount and to remove the tire. This depth of the circumferential groove 30, the function of which is also to allow the bead 5 of the tire 1 to negotiate the seat 24, may preferably range between 10 and 15 mm and more preferably between 12 and 13 mm.

FIG. 6 shows an alternative form of embodiment of a wheel according to the invention. This wheel is intended to accommodate a tire that has no support insert. The rim has a groove 26 adjacent to the first seat and a groove 30 adjacent to the second seat. Each groove acts as a mounting groove to allow the corresponding bead of the tire to negotiate the seat so that it can be fitted when the tire is being fitted or removed.

The groove 30 has a radially inside diameter Φ_{JImax} which is greater than the radially inside diameter Φ_{JImin} of the groove 26. This then produces a retention cavity 280 and once again there is some benefit in having means for removing the various substances that may accumulate in this cavity. In the example depicted, the wheel has passageways 215 which open, on the one side, into the cavity 280 and, on the other side, onto the outside of the disc 21.

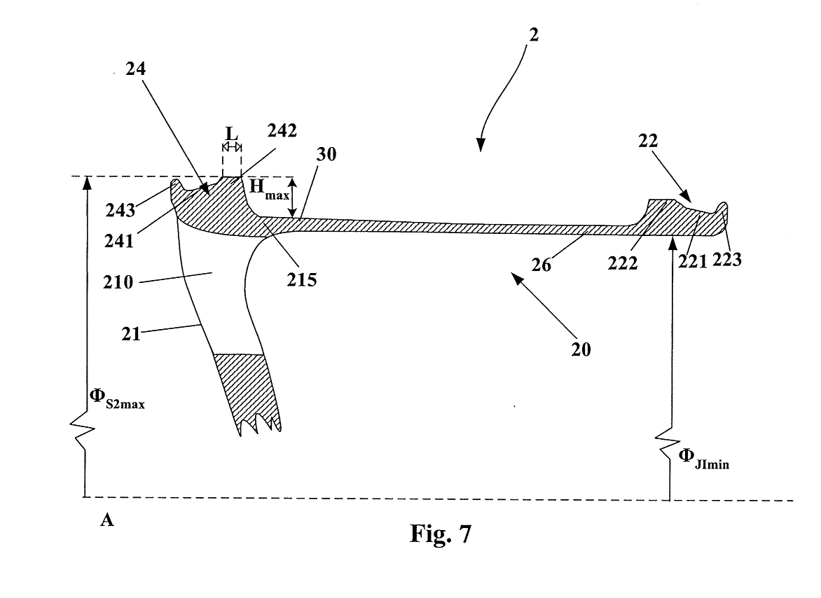

FIG. 7 shows an alternative form of embodiment of a wheel according to the invention, again intended to accept a tire that has no support insert. As before, this wheel has its second seat 24 of a diameter greater than the diameter of the first seat 22. The second seat is positioned on the outboard side of the wheel, in the region of the connection with the disc.

This wheel 2 of FIG. 7 has two grooves 30 and 26 which have more or less the same inside and outside diameter. As a result, the radially internal wall of the rim has no retention cavity.

In order to allow the bead of the tire to be prevented from becoming unseated from the second seat, this second seat is provided with a safety hump or ledge of a width appreciably greater than that of the ledge of the wheel of FIG. 1 against which the sidewall of the groove 30 is going to bear.

This being the case, the depth Hₘₐₓ of the groove 30 has to be appreciably greater and preferably may range between 23 and 27 mm for wheels with a ledge of the order of preferably 15 mm wide. These values make for ease of fitting of the second bead onto the second seat and give excellent anti unseating properties. These values are given for wheels of nominal diameters ranging between 420 and 540 mm.

This wheel has the advantage that it can be produced very easily because it has no undercut parts in its radially internal wall.

The invention is not restricted to the examples described and depicted and various modifications can be made thereto without departing from its scope which is limited only by the claims which follow.

What is claimed is:

1. A vehicle wheel, with symmetry of revolution, comprising a disc and a rim, said rim comprising a first seat and a second seat, wherein said seats are designed to receive and to hold a first bead and a second bead of a tire, wherein each seat comprises
(1) a substantially frustoconical bottom locally coinciding with a cone of revolution coaxial with the rim and open towards the other seat;
(2) a safety hump extending the bottom of the seat towards the other seat;
(3) an external lip extending the bottom of the seat in the direction away from the other seat, wherein the maximum diameter of the first seat is less than the maximum diameter of the second seat; and
(4) an adjacent circumferential groove on a side facing the other respective seat,
wherein the connecting region where the disc and the rim meet is connected to said rim on said second seat side.

2. The wheel according to claim 1, wherein the depth (Hₘₐₓ) of the groove adjacent to the second seat is designed to allow said second bead of the tire to negotiate said second seat without allowing said first bead of the tire to negotiate said second seat.

3. The wheel according to claim 2, wherein the safety hump of said second seat comprises a ledge that is cylindrical of revolution having axial width L, and wherein the depth (Hₘₐₓ) of the groove adjacent to the second seat is dependent on the maximum diameter (Φ_{S2max}) of said ledge and on the axial width L of said ledge.

4. The wheel according to claim 1 further comprising
(1) a radially internal profile of said rim having, progressing from the first seat towards the region of connection with the disc, a diameter that passes through a minimum (Φ_{JImin}) then through a maximum diameter (Φ_{JImax}) positioned axially between said first and second seats; and
(2) at least one passageway that opens into the region of the radially internal profile of the rim and that opens into the outside of the wheel on the second seat side, wherein the passageway has a diameter between from about said maximum diameter (Φ_{JImax}) to about said minimum diameter (Φ_{JImin}).

5. The wheel according to claim 4, wherein said passageway opens into the radially internal region of said rim, wherein said passageway has a diameter (Φ_{CI}) of about the maximum diameter of the internal profile of said rim (Φ_{JImax}) reduced by 3 mm.

6. The wheel according to claim 4 or 5, wherein said passageway coincides locally with a sector of a cone of revolution open towards the second seat.

7. The wheel according to claim 4 or 5, wherein said disc has a number of ventilation openings, and wherein said passageway is a slot formed in the radially external wall of at least one of said openings.

8. The wheel according to claim 4 or 5, wherein said disc has a number of ventilation openings, wherein each opening is positioned between two spokes, and wherein said passageway is formed in at least one of said spokes.

9. The wheel according to one claim 1, 2, 3, 4 or 5, wherein said groove adjacent to said first seat is designed to house a monitoring electronic module.

10. The wheel according to claim 1, 2, 3, 4 or 5, wherein said rim includes a bearing surface having a diameter of about the maximum diameter of said first seat, and wherein said bearing surface is positioned between said grooves.

11. The wheel according to claim 10, wherein the bearing surface comprises a circumferential slot designed to lock said insert in position on said bearing surface.

12. An assembly comprising a wheel according to claim 10, and a tread support insert, wherein said support insert is positioned around said bearing surface and wherein said support insert runs axially as far as the second seat.

13. The assembly according to claim 12, wherein said insert comprises a support part positioned around the bearing surface of said rim and a locking part positioned radially externally relative to said circumferential groove.

14. The assembly according to claim 12 wherein said second seat extends towards the first seat by a sidewall of said second circumferential groove, and wherein said insert is designed to bear against said sidewall of said second circumferential groove.

15. The assembly according to claim 12, wherein said bearing surface comprises a circumferential slot which collaborates with a plurality of wedges positioned circumferentially on the radially internal wall of the support insert to lock said insert in position on said bearing surface.
